(19) United States
(12) Patent Application Publication
(10) Pub. No.: US 2019/0054717 A1
(43) Pub. Date: Feb. 21, 2019

(54) ASYMMETRIC GLASS LAMINATES EXHIBITING IMPROVED DAMAGE TOLERANCE

(71) Applicants: Thomas Michael Cleary, Elmira, NY (US); James Gregory Couilard, Ithaca, NY (US); William Kenneth Denson, Big Flats, NY (US)

(72) Inventors: Thomas Michael Cleary, Elmira, NY (US); James Gregory Couilard, Ithaca, NY (US); William Kenneth Denson, Big Flats, NY (US)

(21) Appl. No.: 15/769,989

(22) PCT Filed: Oct. 20, 2016
(86) PCT No.: PCT/US16/57809

§ 371 Date: Apr. 20, 2018

Related U.S. Application Data
(60) Provisional application No. 62/256,777, filed on Nov. 18, 2015.
(60) Provisional application No. 62/244,383, filed on Oct. 21, 2015.

(51) Int. Cl. B32B 17/10; C03C 21/00

(52) U.S. Cl. CPC B32B 17/10137; B60J 1/001; B32B 17/10119; B32B 17/10761; B32B 17/1077; B32B 17/10788; B32B 17/10871; C03C 21/002; B32B 2315/08; B32B 2327/06; B32B 2329/06; B32B 2331/04; B32B 2375/00; B32B 2605/006; B32B 17/10036

(57) ABSTRACT

Principles and embodiments of the present disclosure relate to unique asymmetric laminates and methods that produce the laminates that have improved damage tolerance, where the laminate includes a first strengthened glass substrate having a first central tension value bonded to a second strengthened glass substrate having a second central tension value by an interlayer, where the first central tension value is less than the second central tension value.

### CROSS-REFERENCE TO RELATED APPLICATIONS

This application claims the benefit of priority under 35 U.S.C. § 119 of U.S. Provisional Application Ser. No. 62/256,777 filed on Nov. 18, 2015 and U.S. Provisional Application Ser. No. 62/244,383 filed on Oct. 21, 2015, the content of which is relied upon and incorporated herein by reference in its entirety.

### TECHNICAL FIELD

Principles and embodiments of the present disclosure relate generally to a laminate comprising strengthened glass substrates, and methods of forming a laminate by bonding glass substrates having different central tension values together with an interlayer.

### BACKGROUND

Laminates comprising opposing glass substrates (which may be sheets) separated by a plasticized poly(vinyl butyral) (PVB) sheet, for example, can be used as windows in vehicles or buildings or as architectural panes and panels. In certain applications, glass laminates having high mechanical strength, resistance to damage from impinging objects, and sound attenuating properties are desirable to provide a safe barrier while reducing the potential of at least one substrate forming the laminate fracturing due to surface cracks.

A glass substrate forming part of a laminate can be strengthened (chemically, thermally, and/or mechanically) to impart a surface compressive stress (CS) to the compressive stress region (or layer) that extends a distance from the surface into the glass substrate, where this distance into the glass substrate is referred to as a depth of compressive stress region (DOC). DOC refers to the depth at which the stress within the glass substrate changes from compressive stress to tensile stress. At the DOC, the stress crosses from a positive (compressive) stress to a negative (tensile) stress and thus exhibits a stress value of zero. According to the convention normally used in the art, compression is expressed as a negative (<0) stress and tension is expressed as a positive (>0) stress. Throughout this description, however, CS is expressed as a positive or absolute value—i.e., as recited herein, CS=|CS|.

In chemically-strengthened glass substrates, the CS region is generated by an ion exchange process. In mechanically-strengthened glass substrates, the CS region is generated by a mismatch of the coefficient of thermal expansion between portions of the substrate. In thermally-strengthened substrates, the CS region is formed by heating the substrate to an elevated temperature above the glass transition temperature, near the glass softening point, and then cooling the glass surface regions more rapidly than the inner regions of the glass. The differential cooling rates between the surface regions and the inner regions generates a residual surface CS.

In these strengthened glasses, the CS induces tensile stress within the core of the material, where the resulting CT region may have maximum central tension values of 50 MPa or greater. The DOC of the resulting strengthened glass substrate may be a few to several tens of microns deep or hundreds of microns deep, depending on the strengthening method used.

In addition to withstanding external scratches, laminates used in automotive glazing must withstand internal impacts and meet safety standards. The ECE R43 headform test, which simulates impact events occurring from inside a vehicle, is a regulatory test that requires that laminates for motor vehicles fracture in response to specified internal impact. The glass is required to break at a certain impact load to prevent injury.

It would be desirable to provide a laminate that is not broken by external impact such as impact from a stone, yet is lighter weight, and is capable of absorbing considerable impact from a human body with out causing serious injury. Improving one property of a glass laminate, however, tends to compromise other qualities of the laminate. It is therefore difficult to produce a laminate having a full range of desirable properties for use as automotive glazings and architectural panes.

### SUMMARY

Principles and embodiments of the present disclosure are directed to laminate glass structures that provide a combination of hardness, resilience, lightweight, high mechanical strength, resistance to damage from impinging objects, and sound attenuating properties.

Various embodiments are listed below. It will be understood that the embodiments listed below may be combined not only as listed below, but in other suitable combinations in accordance with the scope of the disclosure.

In a first embodiment, a laminate comprises a first strengthened glass substrate having a first CT value defined by a first thickness, a first DOC, and a first CS magnitude; and a second strengthened glass substrate having a second CT value defined by a second thickness, a second DOC, and a second surface compressive stress magnitude, wherein the first CT value is less than the second CT value. Unless otherwise noted, CT is indicated as a positive stress value and CS is indicated as a negative stress value.

In a second embodiment, a laminate comprises a first strengthened glass substrate having a first damage tolerance as measured by an Indentation Fracture Measurement; and a second strengthened glass substrate having a second damage tolerance as measured by the same Indentation Fracture Measurement as the first damage tolerance, wherein the first strengthened glass substrate and second strengthened glass substrate are laminated together, and the first damage tolerance is greater than the second damage tolerance. As used herein, damage tolerance refers to the ability of a glass substrate or the laminate to sustain damage and not crack or for the damage not to propagate within and/or through the substrate or laminate, respectively. The damage tolerance may be measured by an Indentation Fracture Measurement, as described herein, in terms of a percentage of samples that survive the measurement using a given load and indenter.

In another embodiment, a method of manufacturing a laminate comprises arranging a first strengthened glass substrate, an interlayer, and a second strengthened glass substrate in a stack; and applying heat and pressure to the stack to form the laminate. In one or more embodiments, the first strengthened glass substrate may include a first CT value defined by a first thickness, a first DOC, and a first surface CS magnitude, and the second strengthened glass substrate may include a second CT value defined by a second thickness, a second DOC, and a second surface CS magnitude. In one or more embodiments, the first CT value is less than the second CT value.

### BRIEF DESCRIPTION OF THE DRAWINGS

Further features of embodiment of the present disclosure, their nature and various advantages will become more apparent upon consideration of the following detailed description, taken in conjunction with the accompanying drawings, which are also illustrative of the best mode contemplated by the applicants, and in which like reference characters refer to like parts throughout, where:

FIG. 1 illustrates an embodiment of a glass substrate surface having a plurality of cracks;

FIG. 2A illustrates an embodiment of a second strengthened glass substrate having a thickness;

FIG. 2B illustrates an embodiment of a first strengthened glass substrate having a thickness;

FIG. 3 illustrates another exemplary embodiment of a laminate comprising a first strengthened glass substrate and a second strengthened glass substrate;

FIG. 4 illustrates a vehicle including a laminate according to one or more embodiments;

FIG. 5 illustrates a side view of the Stone Impact Test;

FIG. 6 illustrates a front view of the Stone Impact Test;

FIG. 7 is a graph showing retained strength results for Examples 2A-2D and Comparative Examples 2E-2H; and

FIG. 8 is a graph showing retained strength results for Example 2J and Comparative Examples 2E and 2I.

### DETAILED DESCRIPTION

Before describing several exemplary embodiments, it is to be understood that the disclosure is not limited to the details of construction or process steps set forth in the following disclosure. The disclosure provided herein is capable of other embodiments and of being practiced or being carried out in various ways.

Reference throughout this specification to “one embodiment,” “certain embodiments,” “various embodiments,” “one or more embodiments” or “an embodiment” means that a particular feature, structure, material, or characteristic described in connection with the embodiment is included in at least one embodiment of the disclosure. Thus, the appearances of the phrases such as “in one or more embodiments,” “in certain embodiments,” “in various embodiments,” “in one embodiment” or “in an embodiment” in various places throughout this specification are not necessarily referring to the same embodiment. Furthermore, the particular features, structures, materials, or characteristics may be combined in any suitable manner in one or more embodiments.

As used herein, the phrase “glass laminates,” which may also referred to as “laminate structures,” laminate glass structures, or “glazings,” relates to a transparent, semitransparent, translucent or opaque glass-based material. In some embodiments, the glass laminates may be utilized in a window, panel, wall, or enclosure, for use in architectural and vehicle or transportation applications, including automobiles, trains (rolling stock or locomotive) and seacraft (boats, ships and the like), aircraft (e.g., airplanes, drones and the like), as well as buildings, signs, and other structures. Laminates according to one or more embodiments comprise at least two glass substrates. The glass substrates include a first and second glass substrate, of which one is an exterior glass substrate defining an outer ply and the other is an internal glass substrate defining an inner ply. In one or more embodiments, the first glass substrate is an exterior glass substrate defining an outer ply and the second glass substrate is an internal glass substrate defining an inner ply. In one or more embodiments, the first glass substrate is an internal glass substrate defining an inner ply, while the second glass substrate is an exterior glass substrate defining an out ply. In vehicle applications such as automotive glazings, the internal ply is exposed to a vehicle interior and the external ply faces an outside environment of the automobile. In architectural applications, the internal ply is exposed to a building, room, or furniture interior and the external ply faces an outside environment of the building, room or furniture. In one or more embodiments, the external glass substrate and internal glass substrate are bonded together by an interlayer.

Glass laminates comprising strengthened glass substrates possess an array of desired properties, including light weight, high impact resistance, and improved sound attenuation. Using strengthened glass substrates for a laminate offers an opportunity of using thinner glass than traditional glazing options thus allowing weight reduction.

During use, it is desirable that the glass laminate resist fracture in response to external impact events. Fracture due to contact induced sub-surface damage has been identified as a failure mechanism. In addition, in response to internal impact events, such as the glass laminates being struck by a vehicle's occupant, it is desirable that the glass laminate retain the occupant in the vehicle yet dissipate energy upon impact in order to minimize injury.

It has been determined that installed automotive glazing may develop external scratches as deep as about 100 μm due to exposure to environmental abrasive materials such as rocks, silica sand, flying debris, etc. This penetration depth typically exceeds the typical depth of compressive layer, which could lead to the glass unexpectedly fracturing. The depth of penetration for the exposed surface of an internal glass substrate is notably lower than for the external glass substrate.

Principles and embodiments of the present disclosure relate to unique asymmetric laminates and methods that produce the asymmetric laminates that have improved damage tolerance, the laminate comprising a first strengthened glass substrate having a first CT value and a second strengthened glass substrate having a second CT value, where the first CT value is less than the second CT value. In one or more embodiments, the first central tension value is defined by a first thickness, a first compressive stress depth of layer, and a first compressive stress magnitude, and the second central tension value is defined by a second thickness, a second compressive stress depth of layer, and a second compressive stress magnitude.

The glass substrates may be strengthened chemically, mechanically, thermally or by various combinations of chemically, mechanically and/or thermally, to impart a compressive stress region with a surface compressive stress value, and a central tension region with a maximum central tension value. Any one or more of the magnitude of the compressive stress, the depth of the compressive stress region (DOC), and the magnitude of the maximum central tension value can be tailored by the strengthening process.

The mechanically-strengthened glass substrates may include a compressive stress region and a central tension region generated by a mismatch of the coefficient of thermal expansion between portions of the substrate. Chemically-strengthened glass substrates may include a compressive stress region and a central tension region generated by an ion exchange process. In chemically strengthened glass substrates, the replacement of smaller ions by larger ions at a temperature below that at which the glass network can relax produces a distribution of ions across the surface of the glass that results in a stress profile. The larger volume of the incoming ion produces a CS on the surface portion of the substrate and tension (CT) in the center of the glass. In thermally-strengthened substrates, the CS region is formed by heating the substrate to an elevated temperature above the glass transition temperature, near the glass softening point, and then cooling the glass surface regions more rapidly than the inner regions of the glass. The differential cooling rates between the surface regions and the inner regions generates a residual surface CS, which in turn generates a corresponding CT in the center region of the glass. In one or more embodiments, the glass substrates exclude annealed or heat strengthened soda lime glass.

CS and DOC may be measured by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured according to a modified version of Procedure C described in ASTM standard C770-98 (2013), entitled “Standard Test Method for Measurement of Glass Stress-Optical Coefficient,” the contents of which are incorporated herein by reference in their entirety. The modification includes using a glass disc as the specimen with a thickness of 5 to 10 mm and a diameter of 12.7 mm, wherein the disc is isotropic and homogeneous and core drilled with both faces polished and parallel. The modification also includes calculating the maximum force, Fmax to be applied. The force should be sufficient to produce at least 20 MPa compression stress. Fmax is calculated as follows:

Fmax=7.854*D*h

Where:

Fmax=Force in Newtons

D=the diameter of the disc

h=the thickness of the light path

For each force applied, the stress is computed as follows:

σ_{MPa}=8F/(π*D*h)

Where:

F=Force in Newtons

D=the diameter of the disc

h=the thickness of the light path

In such embodiments where FSM is utilized, the CT may be approximated by the following approximate relationship (Equation 1):

$$CT ≅ \frac{CS \times DOL}{thickness - 2 \times DOL}$$

where thickness is the total thickness of the strengthened glass substrate. Unless otherwise specified, CT and CS are expressed herein in megaPascals (MPa), whereas thickness and DOC are expressed in millimeters or microns. It will be appreciated that CT is dependent on three parameters—CS, DOC and thickness. As an example, to maintain a CT value, for example at 30 MPa or less, as the DOC is increased, either the CS would need to be decreased or the increase the thickness to maintain the CT at 30 MPa or less.

For strengthened glass-based articles in which the CS layers extend to deeper depths within the glass-based article, additional techniques may be used to determine DOC and/or CT. For example, CT may also be measured using a scattered light polariscope (“SCALP”, supplied by Glasstress Ltd., located in Tallinn, Estonia, under model number SCALP-04) and techniques known in the art. SCALP can also be used to measure the DOC, as will be described in more detail below.

In some embodiments, where the glass substrate is chemically strengthened using a mixture of cations in a single ion exchange process or more than one cation in a multi-step ion exchange process, the magnitude of CS may change as a function of thickness. For example, the where both sodium and potassium cations are used to strengthen the glass, the glass substrate may exhibit a depth of penetration of potassium ions (“Potassium DOL”) that is distinct from the DOC. The degree of difference between DOC and Potassium DOL depends on the glass substrate composition and the ion exchange treatment that generates the stress in the resulting glass substrate. Where the stress in the glass substrate is generated by exchanging potassium ions into the glass substrate, FSM (as described above with respect to CS) is used to measure Potassium DOL. Where the stress is generated by exchanging sodium ions into the glass substrate, SCALP (as described above with respect to CT) is used to measure DOC and the resulting glass substrate will not have a Potassium DOL since there is no penetration of potassium ions. Where the stress in the glass substrate is generated by exchanging both potassium and sodium ions into the glass, the exchange depth of sodium indicates the DOC, and the exchange depth of potassium ions indicates a change in the magnitude of the compressive stress (but not the change in stress from compressive to tensile); in such embodiments, the DOC is measured by SCALP, and Potassium DOL is measured by FSM. Where both Potassium DOL and DOC are present in a glass substrate, the Potassium DOL is typically less than the DOC.

Refracted near-field (RNF) method or SCALP may be used to measure the stress profile in the glass substrate described herein (regardless of whether the stress is generated by sodium ion exchange and/or potassium ion exchange). When the RNF method is utilized, the CT value provided by SCALP is utilized. In particular, the stress profile measured by RNF is force balanced and calibrated to the CT value provided by a SCALP measurement. The RNF method is described in U.S. Pat. No. 8,854,623, entitled “Systems and methods for measuring a profile characteristic of a glass sample”, which is incorporated herein by reference in its entirety. In particular, the RNF method includes placing the glass-based article adjacent to a reference block, generating a polarization-switched light beam that is switched between orthogonal polarizations at a rate of between 1 Hz and 50 Hz, measuring an amount of power in the polarization-switched light beam and generating a polarization-switched reference signal, wherein the measured amounts of power in each of the orthogonal polarizations are within 50% of each other. The method further includes transmitting the polarization-switched light beam through the glass sample and reference block for different depths into the glass sample, then relaying the transmitted polarization-switched light beam to a signal photodetector using a relay optical system, with the signal photodetector generating a polarization-switched detector signal. The method also includes dividing the detector signal by the reference signal to form a normalized detector signal and determining the profile characteristic of the glass sample from the normalized detector signal.

In one or more embodiments in which the stress in a glass substrate is generated by only potassium ion exchange and Potassium DOL is equivalent to DOC, the stress profile may also be obtained by the methods disclosed in U.S. patent application Ser. No. 13/463,322, entitled “Systems And Methods for Measuring the Stress Profile of Ion-Exchanged Glass (hereinafter referred to as “Roussev I”).” filed by Rostislav V. Roussev et al. on May 3, 2012, and claiming priority to U.S. Provisional Patent Application No. 61/489,800, having the same title and filed on May 25, 2011. Roussev I discloses methods for extracting detailed and precise stress profiles (stress as a function of depth) of chemically strengthened glass using FSM. Specifically, the spectra of bound optical modes for TM and TE polarization are collected via prism coupling techniques, and used in their entirety to obtain detailed and precise TM and TE refractive index profiles n_{TM}(z) and n_{TE}(z). The contents of the above applications are incorporated herein by reference in their entirety. The detailed index profiles are obtained from the mode spectra by using the inverse Wentzel-Kramers-Brillouin (IWKB) method, and fitting the measured mode spectra to numerically calculated spectra of pre-defined functional forms that describe the shapes of the index profiles and obtaining the parameters of the functional forms from the best fit. The detailed stress profile S(z) is calculated from the difference of the recovered TM and TE index profiles by using a known value of the stress-optic coefficient (SOC):

S(z)=[n_{TM}(z)−n_{TE}(z)]SOC (2).

Due to the small value of the SOC, the birefringence n_{TM}(z)−n_{TE}(z) at any depth z is a small fraction (typically on the order of 1%) of either of the indices n_{TM}(z) and n_{TE}(z). Obtaining stress profiles that are not significantly distorted due to noise in the measured mode spectra requires determination of the mode effective indices with precision on the order of 0.00001 RIU. The methods disclosed in Roussev I further include techniques applied to the raw data to ensure such high precision for the measured mode indices, despite noise and/or poor contrast in the collected TE and TM mode spectra or images of the mode spectra. Such techniques include noise-averaging, filtering, and curve fitting to find the positions of the extremes corresponding to the modes with sub-pixel resolution.

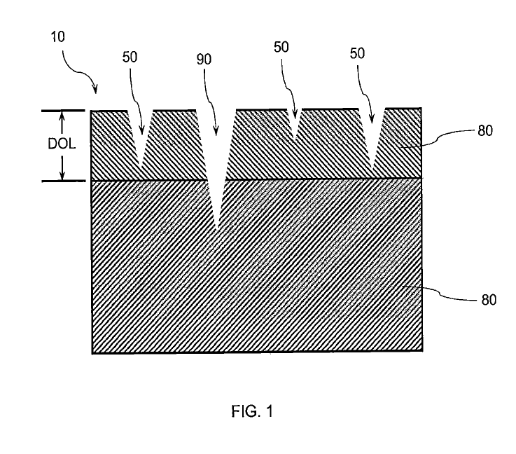

FIG. 1 illustrates a first strengthened glass substrate 10 having a plurality of cracks, illustrating how subsurface damage can result in a fatigue style failure. Three cracks 50 in the CS region 60 of the first strengthened glass substrate 10 that do not extend into the CT region 80 of the glass are shown, along with a single crack 90 that penetrates into the CT region 80 of the glass. Although the incorporation of a CS in a near surface region of the glass can inhibit crack propagation and failure of the glass substrate, if the damage extends beyond the DOC, and if the CT is of a high enough magnitude, the flaw will propagate over time until it reaches the materials critical stress intensity level (fracture toughness) and will ultimately fracture the glass. An analysis of measured flaw depths from used auto glazings comprising an exterior ply and an interior ply showed that the exterior plies have deeper subsurface damage than the interior plies, and the exterior plies are therefore exposed to more severe contact damage.

The CT can be varied by changing the thickness of the strengthened glass substrate, while maintaining the same CS magnitude and DOC.

One or more embodiments pertain to thin, light-weight laminates that can be used for applications such as automotive glazings. In specific embodiments more robust thin, lightweight laminates are provided by reducing the CT of the exterior ply so as to reduce the propensity for subsurface damage fatigue failure of the outer ply. In applications such as automotive glazings, the outer ply typically is subjected to more severe damage resulting in deeper flaw depths, and therefore according to one or more embodiments, the CT in this ply is reduced to make it less prone to fatigue failure. One approach to achieving this reduction in CT is to increase the thickness of the outer ply so that the residual central strain resulting from strengthening has a greater thickness to distribute itself. The magnitude of the resulting CT resulting from the central strain is a function of the thickness it is spread over. The resulting stresses need to be in force balance, and therefore, if the residual CS magnitude and depth are held constant, the only way to reduce the residual tensile stress is to distribute it over a greater depth. The effect of the thickness on CT can be determined by equation 1 above.

Thus, in one or more embodiments, the first CT value can be reduced by increasing the first thickness while keeping a first DOC and a first CS magnitude constant. Another option to reduce the first CT value is to reduce the magnitude of the first CS by changing glass composition or strengthening process conditions for the first substrate. Yet another method to improve fatigue performance is by increasing the DOC to minimize the population of flaws that penetrate beyond the DOC into the CT region. However, making the DOC deeper also increases the CT which increases the risk of fatigue failure for those flaws that do penetrate through. In various embodiments, the first CT value can be reduced by reducing the first CS magnitude, increasing the first DOC, and increasing the first thickness to compensate for the increased first DOC.

A first strengthened glass substrate having a first CT value may be exposed to environmental factors that cause penetrating damage to an exposed surface, for example, as an outward facing surface of an automotive glazing or architectural laminate, whereas a second strengthened glass substrate having a second CT value, may be for example an inward facing surface exposed to different environmental factors, such as blunt impact and scratches.

It has been found that contact damage can generate cracks (i.e., damage to the glass substrate structure that penetrates below the surface of the glass), which penetrate beyond the DOC and into the CT region. Once in the CT region, the internal tension can cause the crack tip to reach its critical stress intensity (K_{Ic}), which is the critical value of stress intensity required to propagate the crack. This critical value determined for mode I loading in plane strain is referred to as the critical fracture toughness (K_{Ic}) of the material. The stress intensity factor (K) for mode I is designated K_{I} and applied to the crack opening mode, where the forces are normal to the direction of the crack. The glass substrate fractures (i.e., separates into two or more pieces) when the crack has propagated through the thickness of the glass. In silicate glasses, the strength of the atomic bonds primarily determines the resistance to fracture. Unlike fatigue, which is typically understood to be due to cyclical loading, the crack propagation and fracture in the compressively/tensilely stressed glass is due to the inherent stress within the glass material itself, and not from an externally applied force. The energy that drives the crack propagation comes from the tensile stresses in the inner region rather than from the force of the impact on the outer surface.

It has also been found that by adjusting the CT value of the strengthened glass substrate, the substrate can be made less susceptible to failure mechanisms initiated by surface damage that penetrates through the DOC to the CT region. The CT value of the strengthened glass substrate may be controlled by adjusting the magnitude of the CS, the DOC, and the thickness of the glass substrate. By minimizing the CT, a more durable (damage tolerant) first strengthened glass substrate is achieved. By increasing the first thickness of the first strengthened glass substrate, the internal stored strain energy of this substrate is reduced to improve its performance to contact damage induced fatigue.

The first strengthened glass substrate provides a first damage tolerance that reduces the probability of the glass failing due to damage and cracks in the glass substrate surface.

The first strengthened glass substrate, which faces an outside environment, may be exposed to more severe contact damage and experience deeper subsurface damage than the second strengthened glass substrate.

One or more embodiments relate to a laminate comprising an first strengthened glass substrate having a first CT value defined by a first thickness, a first DOC, and a first surface CS magnitude; and an second strengthened glass substrate having a second CT value defined by a second thickness, a second DOC, and a second surface CS, wherein the first CT value is less than the second CT value. The laminate may comprise two strengthened glass substrates having different CT values, and does not comprise a non-strengthened glass substrate.

In the various embodiments, the first strengthened glass substrate has a first glass surface and a second glass surface opposite the first glass surface defining a first thickness between the first glass surface and the second glass surface. The first glass surface and second glass surface can be major glass surfaces forming the majority of the first strengthened glass substrate surface area.

In one or more embodiments, the first thickness may be in the range of about 0.05 mm to about 2 mm, for example, in the range of about 0.05 to about 1.9 mm, in the range of about 0.05 to about 1.8 mm, in the range of about 0.05 to about 1.7 mm, in the range of about 0.05 to about 1.6 mm, in the range of about 0.05 to about 1.5 mm, in the range of about 0.05 to about 1 mm, in the range of about 0.1 to about 2 mm, in the range of about 0.3 to about 2 mm, in the range of about 0.4 to about 2 mm, in the range of about 0.5 to about 2 mm, in the range of about 0.7 to about 2 mm, in the range of about 0.8 to about 2 mm, in the range of about 0.4 to about 1.9 mm, or in the range from about 0.4 up to (but not including) about 1.8 mm, or in the range of about 0.4 mm to about 1.7 mm, or in the range of about 0.4 mm to about 1.5 mm, or in the range of about 0.4 mm to about 1.4 mm, or in the range of about 0.4 mm to about 1.2 mm. The thickness values described herein are maximum thicknesses. In one or more embodiments, the first glass substrate has a substantially uniform thickness. In one or more embodiments, the first strengthened glass substrate may have a wedge shape. In such embodiments, the thickness of the first strengthened glass at one edge may be greater than the thickness of the opposite edge. In one or more embodiments, the longest edges of the first glass substrate have thicknesses that differ from one another, while the thicknesses of the other edges (shorter edges) are the same with respect to one another but vary along the length thereof to form the wedge shape. In one or more embodiments in which the first strengthened glass substrate has a wedge shape, the thickness ranges provided above are maximum thicknesses. In one or more embodiments, the first strengthened glass substrate has a wedge shape while the second strengthened glass substrate has a substantially uniform thickness.

In one or more embodiments, the first CT value may be 25 MPa or less, or 30 MPa or less, or 40 MPa or less, or 45 MPa or less. In one or more embodiments, the first strengthened glass substrate may have a CT in the range of about 10 MPa to about 40 MPa, or in the range of about 20 MPa to about 30 MPa, including values of 29 MPa, 28 MPa, 27 MPa, 26 MPa, 25, MPa, 24 MPa, 23 MPa, 22 MPa and 21 MPa and ranges including each of these values as endpoints, for example, the range of about 21 MPa to about 29 MPa.

In one or more embodiments, the first CT value may be controlled by using a different glass composition for the first strengthened glass substrate. In various embodiments, the first strengthened glass substrate has a different glass composition than the second strengthened glass substrate. By using a different glass composition which ion exchanges to a lower CS, a lower CT can be achieved. In some instances, the strengthening process utilized may be modified to control the first CT value.

In one or more embodiments, at least one surface of the first strengthened glass substrate has a first surface CS magnitude (in absolute terms) of at least 300 MPa, or at least 400 MPa, or at least 500 MPa, or at least 600 MPa, or at least 700 MPa, at least 800 MPa, at least 900 MPa, or at least 1000 MPa. In various embodiments, the first CS magnitude may be in the range of about 300 MPa to about 1000 MPa, specifically, in the range of about 400 MPa to about 1000 MPa, or in the range of about 500 MPa to about 1000 MPa, or in the range of about 600 MPa to about 1000 MPa, or in the range of about 700 MPa to about 1000 MPa, or in the range of about 800 MPa to about 1000 MPa. In various embodiments, both surfaces of the first strengthened glass substrate may be strengthened to the same CS magnitude.

In one or more embodiments, the first strengthened glass substrate may have a first DOC of 15 μm or greater, 20 μm or greater, 25 μm or greater, 30 μm or greater, 35 μm or greater, 40 μm or greater, 45 μm or greater, or 50 μm or greater. In one or more embodiments, the first strengthened glass substrate may have any of the above recited DOC values combined with a first surface CS magnitude of at least 300 MPa, or at least 400 MPa, or at least 500 MPa, or at least 600 MPa, or at least 700 MPa, or at least 800 MPa, for example, in the range of about 400 MPa to about 700 MPa, specifically, in the range of 400 MPa to 500 MPa.

In various embodiments, the first DOC may be in the range of about 30 μm to about 175 μm, or in the range of about 30 μm to about 170 μm, or in the range of about 30 μm to about 160 μm, or in the range of about 30 μm to about 150 μm, or in the range of about 30 μm to about 140 μm, or in the range of about 30 μm to about 130 μm, or in the range of about 30 μm to about 120 μm, or in the range of about 30 μm to about 110 μm, or in the range of about 30 μm to about 100 μm, or in the range of about 30 μm to about 90 μm, or in the range of about 30 μm to about 80 μm, or in the range of about 30 μm to about 70 μm, or in the range of about 30 μm to about 60 μm, or in the range of about 30 μm to about 50 μm, 35 μm to about 175 μm, or in the range of about 35 μm to about 170 μm, or in the range of about 35 μm to about 160 μm, or in the range of about 35 μm to about 150 μm, or in the range of about 35 μm to about 140 μm, or in the range of about 35 μm to about 130 μm, or in the range of about 35 μm to about 120 μm, or in the range of about 35 μm to about 110 μm, or in the range of about 35 μm to about 100 μm, or in the range of about 35 μm to about 90 μm, or in the range of about 35 μm to about 80 μm, or in the range of about 35 μm to about 70 μm, or in the range of about 35 μm to about 60 μm, or in the range of about 35 μm to about 50 μm, 40 μm to about 175 μm, or in the range of about 40 μm to about 170 μm, or in the range of about 40 μm to about 160 μm, or in the range of about 40 μm to about 150 μm, or in the range of about 40 μm to about 140 μm, or in the range of about 40 μm to about 130 μm, or in the range of about 40 μm to about 120 μm, or in the range of about 40 μm to about 110 μm, or in the range of about 40 μm to about 100 μm, or in the range of about 40 μm to about 90 μm, or in the range of about 40 μm to about 80 μm, or in the range of about 40 μm to about 70 μm, or in the range of about 40 μm to about 60 m, or in the range of about 40 μm to about 50 μm, or in the range of about 45 μm to about 48 μm, for at least one surface of the first strengthened glass substrate.

In various embodiments, in a non-limiting example, the first CS is in the range of about 300 MPa to about 1000 MPa, the first DOC is in the range of 40 μm to about 80 μm and the CT is less than about 30 MPa.

In various embodiments, each of the two surfaces of the first strengthened glass substrate may have different compressive stress DOC and/or different surface CS magnitude by controlling the strengthening process separately for each substrate surface, as described herein.

Another non-limiting example of an embodiment, would utilize a first strengthened substrate with a lower CS, a reasonably deep DOC, and greater thickness than the second strengthened substrate (which may include a 0.7 mm-thick strengthened glass having a CT of approximately 50 MPa). In a specific, non-limiting example an first strengthened glass substrate has a first thickness of about 1.0 mm, a surface CS magnitude of 450 MPa, and has a DOC of about 40 μm, with a resulting CT value of less than about 20 MPa. This first strengthened substrate would be laminated to a second strengthened substrate, which maybe thinner (e.g., having a thickness of about 0.5 mm) to provide a durable light weight laminate construction.

In various embodiments, the second strengthened glass substrate has a third glass surface and a fourth glass surface opposite the third glass surface defining a second thickness between the third glass surface and the fourth glass surface. The third glass surface and fourth glass surface can be major glass surfaces forming the majority of the second strengthened glass substrate surface area.

In one or more embodiments, the second thickness may be in the range of about 0.05 mm to about 2 mm, for example, in the range of about 0.05 to about 1.9 mm, in the range of about 0.05 to about 1.8 mm, in the range of about 0.05 to about 1.7 mm, in the range of about 0.05 to about 1.6 mm, in the range of about 0.05 to about 1.5 mm, in the range of about 0.05 to about 1 mm, in the range of about 0.1 to about 2 mm, in the range of about 0.3 to about 2 mm, in the range of about 0.4 to about 2 mm, in the range of about 0.5 to about 2 mm, in the range of about 0.7 to about 2 mm, in the range of about 0.8 to about 2 mm, in the range of about 0.4 to about 1.9 mm, or in the range from about 0.4 up to (but not including) about 1.8 mm, or in the range of about 0.4 mm to about 1.7 mm, or in the range of about 0.4 mm to about 1.5 mm, or in the range of about 0.4 mm to about 1.4 mm, or in the range of about 0.4 mm to about 1.2 mm. The thickness values described herein are maximum thicknesses. In one or more embodiments, the second glass substrate has a substantially uniform thickness. In one or more embodiments, the second strengthened glass substrate may have a wedge shape. In such embodiments, the thickness of the second strengthened glass at one edge may be greater than the thickness of the opposite edge. In one or more embodiments, the longest edges of the second glass substrate have thicknesses that differ from one another, while the thicknesses of the other edges (shorter edges) are the same with respect to one another but vary along the length thereof to form the wedge shape. In one or more embodiments in which the second strengthened glass substrate has a wedge shape, the thickness ranges provided above are maximum thicknesses. In one or more embodiments, the second strengthened glass substrate has a wedge shape while the first strengthened glass substrate has a substantially uniform thickness.

In one or more embodiments, the second CT value may be 25 MPa or less, or 30 MPa or less, or 40 MPa or less, or 45 MPa or less. In one or more embodiments, the second strengthened glass substrate may have a CT in the range of about 10 MPa to about 40 MPa, or in the range of about 20 MPa to about 30 MPa, including values of 29 MPa, 28 MPa, 27 MPa, 26 MPa, 25, MPa, 24 MPa, 23 MPa, 22 MPa and 21 MPa and ranges including each of these values as endpoints, for example, the range of about 21 MPa to about 29 MPa.

In one or more embodiments, the second CT value may be controlled by using a different glass composition than the composition used for the first strengthened glass substrate. In some instances, the strengthening process utilized may be modified to control the second CT value.

In one or more embodiments, at least one surface of the second strengthened glass substrate has a second surface CS magnitude of at least 300 MPa, or at least 400 MPa, or at least 500 MPa, or at least 600 MPa, or at least 700 MPa, at least 800 MPa, at least 900 MPa, or at least 1000 MPa. In various embodiments, the second surface CS magnitude may be in the range of about 300 MPa to about 1000 MPa, specifically, in the range of about 400 MPa to about 1000 MPa, or in the range of about 500 MPa to about 1000 MPa, or in the range of about 600 MPa to about 1000 MPa, or in the range of about 700 MPa to about 1000 MPa, or in the range of about 800 MPa to about 1000 MPa. In various embodiments, both surfaces of the second strengthened glass substrate may be strengthened to the same CS magnitude.

In one or more embodiments, the second DOC may be in the range of about 30 μm to about 90 μm, or in the range of about 40 μm to about 80 μm, or in the range of about 40 μm to about 70 μm, or in the range of about 40 μm to about 60 μm, or in the range of about 40 μm to about 50 μm, for at least one surface of the second strengthened glass substrate.

In various embodiments, each of the two surfaces of the second strengthened glass substrate may have different DOC values and/or different surface CS magnitudes from one another by controlling the strengthening process separately for each substrate surface, as described above.

In a non-limiting example of an embodiment of an second strengthened glass substrate, the second thickness is in the range of about 0.3 mm to about 0.5 mm, the second surface CS magnitude is in the range of about 700 MPa to about 800 MPa, the second DOC is in the range of about 45 μm to about 55 μm, and the second CT value is greater than 40 MPa.

In another non-limiting example of an embodiment, an second strengthened glass substrate has a surface CS magnitude of over 700 MPa, and has a DOC of approximately 45 μm and a resulting CT value of approximately 52 MPa.

In one or more embodiments, the ratio of the first thickness to the second thickness is at least 10:1, or at least 9:1, or at least 8:1, or at least 7:1, or at least 6:1, or at least 5:1, or at least 4:1, or at least 3:1, or at least 2:1. In one or more embodiments, the ratio of the first thickness to the second thickness is in the range of about 2:1 to about 10:1, or in the range of about 2:1 to about 9:1, or in the range of about 2:1 to about 8:1, or in the range of about 3:1 to about 10:1, or in the range of about 3:1 to about 9:1, or in the range of about 3:1 to about 8:1, or in the range of about 4:1 to about 10:1, or in the range of about 4:1 to about 9:1, or in the range of about 4:1 to about 8:1, or in the range of about 5:1 to about 10:1, or in the range of about 5:1 to about 9:1, or in the range of about 5:1 to about 8:1.

In one or more embodiments, the laminate is configured to be an automotive glazing for an automobile, and the first strengthened glass substrate defines an outer ply which faces an outside environment of the automobile and the second strengthened glass substrate defines an inner ply which faces an interior of the automobile. In one or more embodiments, the first strengthened glass substrate is mechanically strengthened, while the second strengthened glass substrate is chemically strengthened.

In one or more embodiments, the laminate is configured to be an automotive glazing for an automobile, and the second strengthened glass substrate defines an outer ply which faces an outside environment of the automobile and the first strengthened glass substrate defines an inner ply which faces an interior of the automobile. In one or more embodiments, the first strengthened glass substrate is chemically strengthened; while the second strengthened glass substrate is mechanically strengthened. In some embodiments, both the first and second substrates are chemically strengthened. In other embodiments, both the first and second substrates are mechanically strengthened. Additionally or alternatively, one or both the first and second substrates are strengthened mechanically and chemically.

In one or more embodiments, the laminate is configured to be an architectural glazing, and the first strengthened glass substrate defines an outer ply which faces an outside environment of the architectural structure and the second strengthened glass substrate defines an inner ply which faces an interior of the architectural structure. In one or more embodiments, the first strengthened glass substrate is mechanically strengthened, while the second strengthened glass substrate is chemically strengthened.

In one or more embodiments, the laminate is configured to be an architectural glazing for an automobile, and the second strengthened glass substrate defines an outer ply which faces an outside environment of the architectural structure and the first strengthened glass substrate defines an inner ply which faces an interior of the architectural structure. In one or more embodiments, the first strengthened glass substrate is chemically strengthened; while the second strengthened glass substrate is mechanically strengthened. In some embodiments, both the first and second substrates are chemically strengthened. In other embodiments, both the first and second substrates are mechanically strengthened. Additionally or alternatively, one or both the first and second substrates are strengthened mechanically and chemically.

In one or more embodiments, the first strengthened glass substrate is laminated to the second strengthened glass substrate by an interlayer. In various embodiments, the interlayer is a polymer interlayer selected from the group consisting of polyvinyl butyral (PVB), ethylenevinylacetate (EVA), polyvinyl chloride (PVC), ionomers, and thermoplastic polyurethane (TPU). A thermoplastic material such as PVB may be applied as a preformed polymer interlayer.

The interlayer may have a thickness of at least 0.125, or at least 0.25, or at least 0.38, or at least 0.5, or at least 0.7, or at least 0.76, or at least 0.81, or at least 1.0 mm, or at least 1.14, or at least 1.19, or at least 12 mm. The interlayer may have a thickness of less than or equal to 1.6 mm (e.g., from 0.4 to 1.2 mm, such as about 0.4, 0.5, 0.6, 0.7, 0.8, 0.9, 1.0, 1.1 or 1.2 mm). In various embodiments, the interlayer can cover most or, preferably, substantially all of the two opposed major faces of the strengthened glass substrates. The interlayer may also cover the edge faces of the strengthened glass substrates. In one or more embodiments, the interlayer may have a wedge shape or may have a substantially uniform thickness. In one or more embodiments, the thickness of the interlayer along an edge may be greater than the thickness of the interlayer along an opposing edge. In one or more embodiments, the longest edges of the interlayer have thicknesses that differ from one another, while the thicknesses of the other edges (shorter edges) are the same with respect to one another but vary along the length thereof to form the wedge shape. In one or more embodiments in which the interlayer has a wedge shape, the thickness ranges provided above are maximum thicknesses. In one or more embodiments, the interlayer has a wedge shape while the first strengthened glass substrate and/or the second glass substrate has a substantially uniform thickness.

The strengthened glass substrates in contact with the interlayer may be heated above the softening point of the interlayer, such as, for example, at least 50° C. or 100° C. above the softening point, to promote bonding of the interlayer material to the respective strengthened glass substrates. The heating can be performed with the glass in contact with the interlayer under pressure. Strengthened glass substrates can be used to form the glass laminate.

In one or more embodiments, the laminate may have added functionality in terms of incorporating display aspects (e.g., heads up display, projection surfaces, and the like), antennas, solar insulation, acoustic performance (e.g., sound dampening), anti-glare performance, anti-reflective performance, scratch-resistance and the like. Such functionality may be imparted by coatings or layers applied to the exposed surfaces of the laminate or to interior (unexposed) surfaces between laminate substrates (e.g., between the glass substrates or between a glass substrate and an interlayer). In some embodiments, the laminate may have a thickness or configuration to enable improved optical performance when the laminate is used as a heads-up display (e.g., by incorporating a wedged shaped polymer interlayer between the glass sheets or by shaping one of the glass substrates to have a wedged shape). In one or more embodiments, the laminate includes a textured surface that provides anti-glare functionality and such textured surface may be disposed on an exposed surface or an interior surface that is unexposed. In one or more embodiments, the laminate may include an anti-reflective coating, an scratch-resistant coating or a combination thereof disposed on an exposed surface. In one or more embodiments, the laminate may include an antenna disposed on an exposed surface, and interior surface that is not exposed or embedded in any one of the glass substrates. In one or more embodiments, the polymer interlayer can be modified to have one or more of the following properties: ultraviolet (UV) absorption, Infrared (IR) absorption, IR reflection, acoustic control/dampening, adhesion promotion, and tint. The polymer interlayer can be modified by a suitable additive such as a dye, a pigment, dopants, etc. to impart the desired property.

The improved mechanical performance of the laminates described herein can prolong the life thereof and reduce replacement rates of such laminates. This becomes more beneficial as such laminates incorporate the added functionality described herein, and thus become more costly to repair or replace. In some embodiments, the prolonged life and reduced replacement rates are even more beneficial when the laminates with added functionality are used in auto glazing or, more specifically, as high performance windshields.

In various embodiments, the thickness of the first glass substrate may be maximized to reduce the first CT, and the thickness of the second glass substrate may be minimized to achieve a targeted total glass laminate thickness. The asymmetrical glass laminate allows a thinner first glass substrate and a thinner second glass substrate while maintaining edge strength, flexural surface strength, and impact resistance.

In one or more embodiments, the total thickness of the laminate is less than 2.5 mm, and the thickness of an interlayer is less than 0.8 mm.

In a non-limiting example of an embodiment of a laminate, the first strengthened glass substrate has a first thickness of 1.1 mm and the second strengthened glass substrate has a second thickness of 0.5 mm. The interlayer may have a thickness of about 0.76 mm.

An aspect of the disclosure relates to a laminate comprising an first strengthened glass substrate having a first damage tolerance as measured by Indentation Fracture Measurement; and an second strengthened glass substrate having a second damage tolerance as measured by the same Indentation Fracture Measurement as the first damage tolerance, wherein the first strengthened glass substrate and the second strengthened glass substrate are laminated together, and the first damage tolerance is greater than the second damage tolerance.

In one or more embodiments, at least one surface of the first strengthened glass substrate can withstand a surface flaw having a depth of at least 100 μm, at least 95 μm, at least 90 μm, at least 85 μm, at least 80 μm, at least 75 μm, at least 70 μm, at least 65 μm, at least 60 μm, at least 55 μm, or at least 50 μm before the laminate suffers a fatigue-style failure.

The materials for the first strengthened glass substrate and the second strengthened glass substrate may be varied. According to one or more embodiments, the materials for the first strengthened glass substrate and the second strengthened glass substrate may be the same material or different materials. In exemplary embodiments, one or both of the first strengthened glass substrate and the second strengthened glass substrate may be glass (e.g., soda lime glass, alkali aluminosilicate glass, alkali containing borosilicate glass and/or alkali aluminoborsilicate glass) or glass-ceramic (including Li₂O—Al₂O₃—SiO₂ system (i.e. LAS-System) glass ceramics, MgO—Al₂O₃—SiO₂ System (i.e. MAS-System) glass ceramics, glass ceramics including crystalline phases of any one or more of mullite, spinel, α-quartz, β-quartz solid solution, petalite, lithium dissilicate, β-spodumene, nepheline, and alumina).

In some embodiments, the compositions used for a glass substrate may be batched with 0-2 mol. % of at least one fining agent selected from a group that includes Na₂SO₄, NaCl, NaF, NaBr, K₂SO₄, KCl, KF, KBr, and SnO₂.

The substrates may be provided using a variety of different processes. For instance, where the substrate includes a glass substrate, exemplary glass substrate forming methods include float glass processes and down-draw processes such as fusion draw and slot draw.

A glass substrate prepared by a float glass process may be characterized by smooth surfaces and uniform thickness is made by floating molten glass on a bed of molten metal, typically tin. In an example process, molten glass that is fed onto the surface of the molten tin bed forms a floating glass ribbon. As the glass ribbon flows along the tin bath, the temperature is gradually decreased until the glass ribbon solidifies into a solid glass substrate that can be lifted from the tin onto rollers. Once off the bath, the glass substrate can be cooled further and annealed to reduce internal stress.

Down-draw processes produce glass substrates having a uniform thickness that possess relatively pristine surfaces. Because the average flexural strength of the glass substrate is controlled by the amount and size of surface flaws, a pristine surface that has had minimal contact has a higher initial strength. When this high strength glass substrate is then further strengthened (e.g., chemically), the resultant strength can be higher than that of a glass substrate with a surface that has been lapped and polished. Down-drawn glass substrates may be drawn to a thickness of less than about 2 mm. In addition, down drawn glass substrates have a very flat, smooth surface that can be used in its final application without costly grinding and polishing.

The fusion draw process, for example, uses a drawing tank that has a channel for accepting molten glass raw material. The channel has weirs that are open at the top along the length of the channel on both sides of the channel. When the channel fills with molten material the molten glass overflows the weirs. Due to gravity, the molten glass flows down the outside surfaces of the drawing tank as two flowing glass films. These outside surfaces of the drawing tank extend down and inwardly so that they join at an edge below the drawing tank. The two flowing glass films join at this edge to fuse and form a single flowing glass substrate. The fusion draw method offers the advantage that, because the two glass films flowing over the channel fuse together, neither of the outside surfaces of the resulting glass substrate comes in contact with any part of the apparatus. Thus, the surface properties of the fusion drawn glass substrate are not affected by such contact.

The slot draw process is distinct from the fusion draw method. In slot draw processes, the molten raw material glass is provided to a drawing tank. The bottom of the drawing tank has an open slot with a nozzle that extends the length of the slot. The molten glass flows through the slot/nozzle and is drawn downward as a continuous substrate and into an annealing region.

Once formed, a glass substrate may be strengthened to form a strengthened glass substrate, as described herein. It should be noted that glass ceramic substrates may also be strengthened in the same manner as glass substrates.

Examples of glasses that may be used in the substrate may include alkali aluminosilicate glass compositions or alkali aluminoborosilicate glass compositions, though other glass compositions are contemplated. Such glass compositions may be characterized as ion exchangeable. As used herein, “ion exchangeable” means that a substrate comprising the composition is capable of exchanging cations located at or near the surface of the substrate with cations of the same valence that are either larger or smaller in size. One example glass composition comprises SiO₂, B₂O₃ and Na₂O, where (SiO₂+B₂O₃)≥66 mol. %, and Na₂O≥9 mol. %. Suitable glass compositions, in some embodiments, further comprise at least one of K₂O, MgO, and CaO. In a particular embodiment, the glass compositions used in the substrate can comprise 61-75 mol. % SiO₂; 7-15 mol. % Al₂O₃; 0-12 mol. % B₂O₃; 9-21 mol. % Na₂O; 0-4 mol. % K₂O; 0-7 mol. % MgO; and 0-3 mol. % CaO.

A further example glass composition suitable for the substrate comprises: 60-70 mol. % SiO₂; 6-14 mol. % Al₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm Sb₂O₃; where 12 mol. %≤(Li₂O+Na₂O+K₂O)≤20 mol. % and 0 mol. %≤(MgO+CaO)≤10 mol. %.

A still further example glass composition suitable for the substrate comprises: 63.5-66.5 mol. % SiO₂; 8-12 mol. % Al₂O₃; 0-3 mol. % B₂O₃; 0-5 mol. % Li₂O; 8-18 mol. % Na₂O; 0-5 mol. % K₂O; 1-7 mol. % MgO; 0-2.5 mol. % CaO; 0-3 mol. % ZrO₂; 0.05-0.25 mol. % SnO₂; 0.05-0.5 mol. % CeO₂; less than 50 ppm As₂O₃; and less than 50 ppm Sb₂O₃; where 14 mol. %≤(Li₂O+Na₂O+K₂O)≤18 mol. % and 2 mol. %≤(MgO+CaO)≤7 mol. %.

In a particular embodiment, an alkali aluminosilicate glass composition suitable for the substrate comprises alumina, at least one alkali metal and, in some embodiments, greater than 50 mol. % SiO₂, in other embodiments at least 58 mol. % SiO₂, and in still other embodiments at least 60 mol. % SiO₂, wherein the ratio ((Al₂O₃+B₂O₃)/Σ modifiers)>1, where in the ratio the components are expressed in mol. % and the modifiers are alkali metal oxides. This glass composition, in particular embodiments, comprises: 58-72 mol. % SiO₂; 9-17 mol. % Al₂O₃; 2-12 mol. % B₂O₃; 8-16 mol. % Na₂O; and 0-4 mol. % K₂O, wherein the ratio ((Al₂O₃+B₂O₃)/Σ modifiers)>1.

In still another embodiment, the substrate may include an alkali aluminosilicate glass composition comprising: 64-68 mol. % SiO₂; 12-16 mol. % Na₂O; 8-12 mol. % Al₂O₃; 0-3 mol. % B₂O₃; 2-5 mol. % K₂O; 4-6 mol. % MgO; and 0-5 mol. % CaO, wherein: 66 mol. %≤SiO₂+B₂O₃+CaO≤69 mol. %; Na₂O+K₂O+B₂O₃+MgO+CaO+SrO>10 mol. %; 5 mol. %≤MgO+CaO+SrO≤8 mol. %; (Na₂O+B₂O₃)−Al₂O₃≤2 mol. %; 2 mol. %≤Na₂O−Al₂O₃≤6 mol. %; and 4 mol. %≤(Na₂O+K₂O)−Al₂O₃≤10 mol. %.

In an alternative embodiment, the substrate may comprise an alkali aluminosilicate glass composition comprising: 2 mol % or more of Al₂O₃ and/or ZrO₂, or 4 mol % or more of Al₂O₃ and/or ZrO₂.

In various embodiments, the first strengthened glass substrate exhibits a first damage tolerance after being subjected to an Indentation Fracture Measurement, as described herein. In some embodiments, the first strengthened glass substrate exhibits a first damage tolerance that includes at least 50% survival under the Indentation Fracture Measurement, using a Vickers indenter and a load of at least 8 N, or at least 10 N, or at least 12 N, or at least 14 N, or at least 16 N, or at least 20 N (before the first strengthened glass substrate fractures). In one or more embodiments, the first damage tolerance may be exhibited as measured by an Indentation Fracture Measurement using a Vickers indenter and a load in the range of 8 N to 20 N, in the range of 8 N to 16 N, in the range of 10 N to 20 N, in the range of 10 N to 16N or in the range of 12 N to 20 N. As used herein, “Indentation Fracture Measurement” refers to a test utilizing an indenter (such as a Vickers diamond indenter having a 136° pyramidal diamond indenter that forms a square indent) to impart damage to the laminate, according to the following description. The indenter is pressed into the glass substrate by an accurately controlled test load at the specified value. After the desired test load is applied, the glass substrate is moved with respect to the indenter to produce a scratch having a length of 5-10 mm. Five parallel scratches of approximately the same length and spaced apart in the range of 10-20 mm are produced using the same procedure. The size of the sample used for such a test can be 2.54 cm×2.54 cm or 5.08 cm×5.08 cm. The parts are monitored for up to a month for fatigue fracture. The damage tolerance of the first strengthened glass substrate may be about 50% or greater, wherein at least 50% of a minimum of ten samples survives the Indentation Fracture Measurement using the load ranges provided above. In one or more embodiments, the laminate (or one or more substrates of the laminate) exhibits a 50% or greater (e.g., 60% or greater, 70% or greater, 80% or greater or 90% or greater) survival rate under the Indentation Fracture Measurement, using a 20N load. Such survival is exhibited in laminates including at least one substrate having a thickness of 1 mm or less (e.g., 0.9 mm or less, 0.8 mm or less, or 0.7 mm or less).

In one or more embodiments, the first strengthened glass substrate can withstand a surface flaw having a depth of at least 100 μm, or at least 90 μm, or at least 90 μm, before the first strengthened glass substrate fractures.

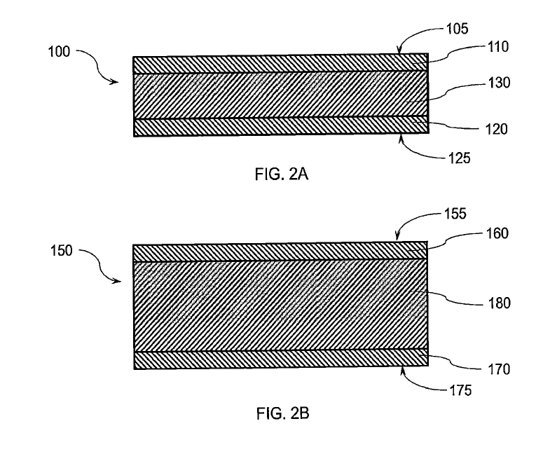

FIG. 2A illustrates an embodiment of an second strengthened glass substrate. The second strengthened glass substrate 100 has a first glass surface 105 and a second glass surface 125 opposite the first glass surface, where each of the glass surfaces may be ion exchanged to provide chemical strengthening. The compressive stress regions 110, 120 of the second strengthened glass substrate 100 extend inward from each surface to a DOC, and the central tension region 130 of the glass is between the two compressive stress regions 110, 120.

FIG. 2B Illustrates an embodiments of a first strengthened glass substrate 150. The first strengthened glass substrate 150 has a third glass surface 155 and a fourth glass surface 175 opposite the first glass surface, where each of the glass surfaces may be ion exchanged to provide chemical strengthening. The CS regions 160, 170 of the first strengthened glass substrate 150 extend inward from each surface to a DOC, and the CT region 180 of the glass is between the two CS regions 160, 170.

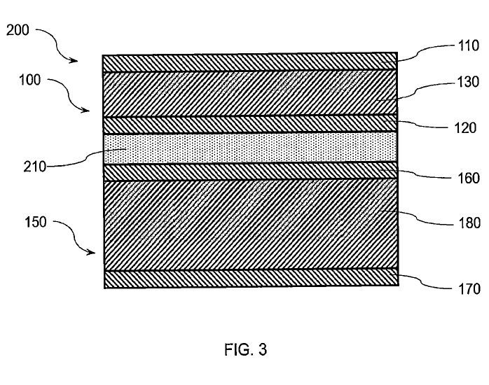

FIG. 3 illustrates an embodiment of a laminate having a first strengthened glass substrate and a second strengthened glass substrate. The laminate 200 comprises a first strengthened glass substrate 150 having a first thickness laminated by an interlayer 210 to a second strengthened glass substrate 100 having a second thickness different than the first thickness. The interlayer may be a polymer interlayer selected from the group consisting of polyvinyl butyral, ethylenevinylacetate, polyvinyl chloride, ionomers, and thermoplastic polyurethane.

Another aspect of the present disclosure relates to a method of manufacturing a laminate comprising arranging an first strengthened glass substrate, an interlayer, and an second strengthened glass substrate in a stack, where the first strengthened glass substrate has a first central tension value and the second strengthened glass substrate has a second substrate central tension value, wherein the first central tension value is less than the second central tension value; and applying heat and pressure to the stack to form the laminate.

In various embodiments, the polymer interlayer can comprise a monolithic polymer sheet, a multilayer polymer sheet, or a composite polymer sheet. The polymer interlayer can be, for example, a plasticized polyvinyl butyral (PVB) sheet.

In various embodiments, the laminate may be formed by placing the strengthened glass substrates and interlayer in a pre-press to tack the interlayer to the strengthened glass substrates. Tacking can include expelling most of the air from the interfaces and partially bonding the interlayer to the glass substrates.

During a lamination process, the interlayer may be heated to a temperature effective to soften the interlayer, which promotes a conformal mating of the interlayer to respective surfaces of the strengthened glass substrates. For PVB, a lamination temperature can be about 140° C. The mobile polymer chains within the interlayer material develop bonds with the substrate surfaces, which promote adhesion. Elevated temperatures also accelerate the diffusion of residual air and/or moisture from the glass-polymer interface. The heating can be performed with the glass substrate(s) in contact with the interlayer under pressure. In various embodiments, the application of pressure both promotes flow of the interlayer material, and suppresses bubble formation that otherwise could be induced by the combined vapor pressure of water and air trapped at the interfaces. In various embodiments, a forming process can occur at or just above the softening temperature of the interlayer material (e.g., about 100° C. to about 120° C.), that is, at a temperature less than the softening temperature of the respective strengthened glass substrate(s).

In one or more embodiments, the heat and pressure can be simultaneously applied to the assembly in an autoclave. In various embodiments, the stack of a first strengthened glass substrate, an interlayer, and a second strengthened glass substrate may be placed within a vacuum bag or a vacuum ring for processing. In various embodiments, the stack and vacuum bag or vacuum ring may be placed with the autoclave.

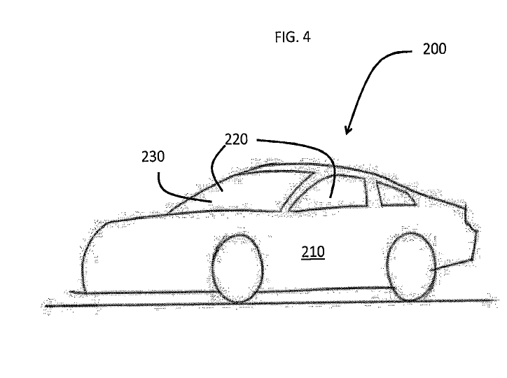

As illustrated in FIG. 4, another aspect of this disclosure pertains to a vehicle 400 comprising a vehicle body 410 defining an interior and comprising at least one opening 420 forming a window to an exterior; and the laminate 230 according to any one of the embodiments described herein disposed in the opening. The vehicle may include an automobile, seacraft, aircraft, or a train, as described herein. In one or more embodiments, the first strengthened glass substrate faces the exterior and the second strengthened glass substrate faces the interior. In one or more embodiments, the first strengthened glass substrate faces the interior and the second strengthened glass substrate faces the exterior.

Another aspect of this disclosure pertains to an architectural element comprising a body defining an interior and comprising at least one opening forming a window to an exterior; and the laminate according to any one of the embodiments described herein disposed in the opening. The architectural element may include a panel, a building, an appliance or other structure. In one or more embodiments, the first strengthened glass substrate faces the exterior and the second strengthened glass substrate faces the interior. In one or more embodiments, the first strengthened glass substrate faces the interior and the second strengthened glass substrate faces the exterior.

### EXAMPLES

The following non-limiting examples demonstrate principles according to one or more embodiments of the disclosure.

### Example 1

Fatigue testing was performed on different glass compositions, demonstrating that the different glass compositions have varying degrees of damage using the Indentation Fracture Measurement described above. In the Indentation Fracture Measurement, a diamond Vickers indenter was used at various loads, as shown in Table 1. The parts were subsequently allowed to age for up to a month and monitored for fatigue fracture. Table 1 shows the results of Indentation Fracture Measurement. The Table shows the percentage of failures of examples of different chemically strengthened glass substrates. Compressive stress (CS) is in MPa, DOC is in microns, Central Tension (CT) is in MPa, and thickness (T) is in millimeters. CS, DOC and CT were measured or approximated using FSM.

TABLE 1
Percentage of Failures under Indentation Fracture
Measurement.

| | Sample 1: | Sample 2: | Sample 3: | Sample 4: | Sample 5: | Sample 6: |
|---|---|---|---|---|---|---|
| | CS: 695 | CS: 690 | CS: 415 | CS: 719 | CS: 722 | CS: 430 |
| | DOC: 41 | DOC: 43 | DOC: 40 | DOC: 49 | DOC: 45 | DOC: 39 |
| | CT: 46.1 | CT: 40.4 | CT: 27 | CT: 32 | CT: 26.9 | CT: 18.2 |
| Load (N) | T: 0.7 | T: 0.8 | T: 0.7 | T: 1.1 | T: 1.3 | T: 1.0 |
| 2 | 0% | 0% | 0% | No Test | No Test | No Test |
| 4 | 0% | 0% | 0% | 0% | 0% | 0% |
| 6 | 0% | 5% | 0% | No Test | No Test | No Test |
| 8 | 21% | 2% | 0% | 0% | 0% | 0% |
| 10 | 40% | 24% | 0% | No Test | No Test | No Test |
| 12 | 80% | 40% | 0% | 12% | 0% | 0% |
| 16 | No Test | No Test | No Test | 24% | 0% | 0% |
| 20 | No Test | No Test | No Test | 55% | 4% | 7% |
| 24 | No Test | No Test | No Test | 63% | 17% | 69% |
| 28 | No Test | No Test | No Test | No Test | No Test | No Test |

It can be seen that for each example, the glass substrate can withstand greater damage as the thickness increases and the CT is thereby decreased.

### Example 2

Examples 2A-2D included combinations of a chemically strengthened glass substrate disposed on a mechanically strengthened glass substrate, with adhesive tape between the two substrates (and no interlayer). The chemically strengthened glass substrates included a thickness of 0.7 mm and a CS of approximately 700 MPa and a DOC of 45 micrometers (as measured by FSM). The thickness, CS and DOC of the mechanically strengthened glass substrate differed among Examples 2A-2D, as shown in Table 2.

TABLE 2
Examples 2A-2D
Mechanically Strengthened Glass Substrate Attributes

| | Thickness | | DOC | | Surviving |
|---|---|---|---|---|---|
| Ex. | (mm) | CS (MPa) | (micrometers) | CT (MPa) | (out of 10) |
| 2A | 1 | 150 | 71 | 25 | 10 |
| 2B | 1 | 190 | 50 | 21 | 10 |
| 2C | 0.7 | 190 | 50 | 31.67 | 10 |
| 2D | 0.7 | 180 | 70 | 45 | 9 |

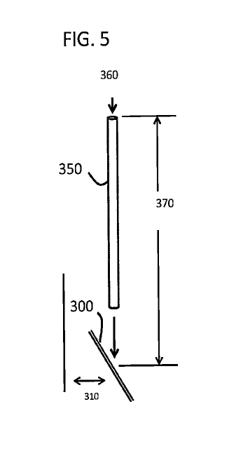

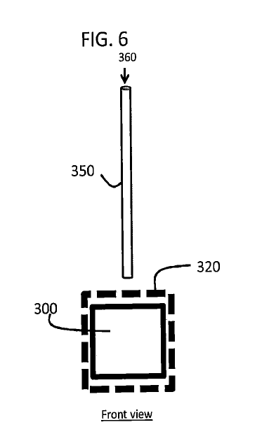

Ten samples of each of Examples 2A-2D were subjected to the following Stone Impact Test. Referring to FIGS. 5 and 6, each sample 300 was positioned at 30 degrees from normal 310 (as specifically shown in FIG. 5), with the mechanically strengthened glass substrate facing toward tube 350. Each sample was supported by a polyvinyl chloride frame including a neoprene insert having a 70 duro hardness, 1 inch width and ⅛ inch thickness, as shown in FIG. 6. After each sample is positioned in the frame in this manner, 12 ounces of SAE G699 grade gravel 360 was poured a few pieces at a time through the tube 350 made of Plexiglass® suspended over the sample 300. The gravel impacted the surface of the mechanically strengthened glass substrate at a drop height 370 (i.e., the distance between the gravel 360 and the top surface of the mechanically strengthened glass substrate was 6 feet). The number of samples (out of the ten samples tested for each of Examples 2A-2D) that survived by not fracturing or breaking is shown in Table 2.

After the samples of Examples 2A-2D were subjected to the Stone Impact Test, the mechanically strengthened glass substrates were separated from the chemically strengthened substrate and adhesive tape, and individually subjected to ring-on-ring load to failure testing according to ASTM C1499 to demonstrate the retention of average flexural strength of the mechanically strengthened glass substrate. The ring-on-ring load to failure testing parameters included a contact radius of 1.6 mm, a cross-head speed of 1.2 mm/minute, a load ring diameter of 0.5 inches, and a support ring diameter of 1 inch. The surface of the mechanically strengthened glass substrate impacted by the gravel was placed in tension. Before testing, an adhesive film was placed on both sides of the substrate being tested to contain broken glass shards.

Comparative Examples 2E-2H each included annealed or heat strengthened soda lime silicate glass substrates having the thicknesses shown in Table 3. Ten samples each of Comparative Examples 2E-2H were subjected to the same Stone Impact Test as Examples 2A-2D. The ten samples each of Comparative Examples 2E-2H were also then subjected to ring-on-ring testing in the same manner as the mechanically strengthened substrates of Examples 2A-2D.

TABLE 3
Comparative Examples 2E-2H

| Comparative | | Thickness |
|---|---|---|
| Ex. | Type | (mm) |
| 2E | Annealed | 2.1 |
| 2F | Heat | 1.8 |
| | strengthened | |
| 2G | Heat | 2.1 |
| | strengthened | |
| 2H | Heat | 2.3 |
| | strengthened | |

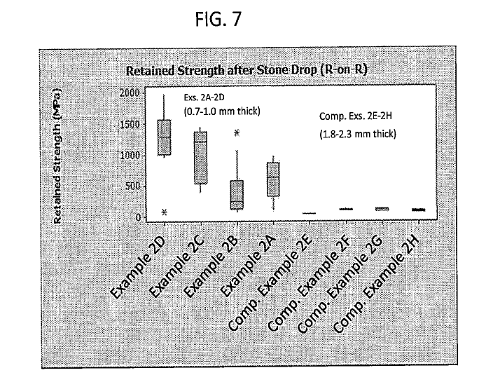

The retained strength results are shown in FIG. 7, which show that even when much thinner mechanically strengthened glass substrates are damaged under the Stone Impact Test, such substrates exhibited significantly higher load to failure values than much thicker substrates that are damaged in the same manner (i.e., by the stone impact test). Specifically, the mechanically strengthened substrates of Examples 2C and 2D, having a CT of 30 MPa or greater, exhibited significantly greater load to failure than Comparative Examples 2E-2H.

Without being bound by theory, it is believed that laminates including the mechanically strengthened substrates described herein exhibit improved survival in the Stone Impact Test due to the strength of individual substrate, even when such substrates have a thickness of about 1 mm or less (e.g., 0.7 mm). It is also believed that the survival improves when combined with a strengthened glass substrate.

The retained strength of Comparative Example 2E was compared to the retained strength of a 6 mm-thick chemically strengthened soda lime glass substrate (Comparative Example 2I) and a 2 mm-thick mechanically strengthened glass substrate (Example 2J). Comparative Examples 2E and 2I and Example 2J were subjected to the Stone Impact Test (as single substrates) prior to being tested by Ring-on-Ring testing. Both the Stone Impact Test and the ring-on-ring load to failure test were conducted in the same manner as Examples 2A-2D.

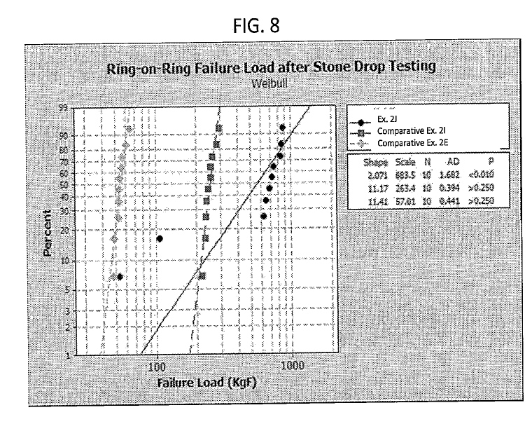

FIG. 8 shows the respective retained strength for Comparative Example 2E, Comparative Example 2I and Example 2J. As shown in FIG. 8, Example 2J exhibited significantly greater load to failure than Comparative Example 2E (which had a comparable thickness to Example 2J) and Comparative Example 2I (which had thickness three times the thickness of Example 2J).

Aspect (1) of this disclosure pertains to a laminate comprising: a first strengthened glass substrate having a first central tension value defined by a first thickness, a first compressive stress depth of layer, and a first compressive stress magnitude; and a second strengthened glass substrate having a second central tension value defined by a second thickness, a second compressive stress depth of layer, and a second compressive stress magnitude, wherein the first central tension value is less than the second central tension value.

Aspect (2) of this disclosure pertains to the laminate of Aspect (1), wherein the first central tension value is 20 MPa or less.

Aspect (3) of this disclosure pertains to the laminate of any one or both of Aspect (1) and Aspect (2), wherein the second compressive stress depth of layer is greater than 40 μm.

Aspect (4) of this disclosure pertains to the laminate of any one or more of Aspect (1) through Aspect (3), wherein the first compressive stress depth of layer is at least 45 μm, and the first central tension value is 30 MPa or less.

Aspect (5) of this disclosure pertains to the laminate of any one or more of Aspect (1) through Aspect (4), wherein the first thickness is in the range of about 0.3 mm to about 2 mm, the first compressive stress magnitude is in the range of about 300 MPa to about 1000 MPa, and the first central tension value is 30 MPa or less.

Aspect (6) of this disclosure pertains to the laminate of any one or more of Aspect (1) through Aspect (5), wherein the first strengthened glass substrate has a different glass composition than the second strengthened glass substrate.

Aspect (7) of this disclosure pertains to the laminate of any one or more of Aspect (1) through Aspect (6), wherein the first strengthened glass substrate is laminated to the second strengthened glass substrate by an interlayer.

Aspect (8) of this disclosure pertains to the laminate of Aspect (7), wherein the interlayer is a polymer interlayer selected from the group consisting of polyvinyl butyral, ethylenevinylacetate, polyvinyl chloride, ionomers, and thermoplastic polyurethane.

Aspect (9) of this disclosure pertains to the laminate of any one or more of Aspect (1) through Aspect (8), wherein the first thickness is greater than the second thickness, and the first thickness is in the range of 0.3 to 2 mm.

Aspect (10) of this disclosure pertains to the laminate of Aspect (9), wherein a ratio of the first thickness to the second thickness is in the range of 2:1 to 10:1.

Aspect (11) of this disclosure pertains to the laminate of Aspect (10), wherein the thickness of the laminate is less than 2.5 mm.

Aspect (12) of this disclosure pertains to the laminate of any one or more of Aspect (1) through Aspect (11), wherein the first compressive stress depth of layer is in the range of about 20 μm to about 170 μm for at least one surface.

Aspect (13) of this disclosure pertains to the laminate of Aspect (12), wherein at least one surface of the first strengthened glass substrate has a compressive stress magnitude of at least 300 MPa.

Aspect (14) of this disclosure pertains to the laminate of any one or more of Aspect (1) through Aspect (13), wherein the laminate comprises any one of a heads-up display, a projection surface, an antenna, a surface modification and a coating.

Aspect (15) of this disclosure pertains to a laminate comprising, a first strengthened glass substrate having a first damage tolerance as measured by an Indentation Fracture Measurement; and a second strengthened glass substrate having a second damage tolerance as measured by the same Indentation Fracture Measurement as the first damage tolerance, wherein the first strengthened glass substrate and the second strengthened glass substrate are laminated together, and the first damage tolerance is greater than the second damage tolerance.

Aspect (16) of this disclosure pertains to the laminate of Aspect (15), wherein at least one surface of the first strengthened glass substrate can withstand a surface flaw having a depth of at least 100 μm before the laminate suffers a fatigue-style failure.

Aspect (17) of this disclosure pertains to the laminate of any one or both of Aspect (15) through Aspect (16), wherein the first strengthened glass substrate can withstand an indentation Fracture Measurement using a Vickers indenter and a load in the range of 8 N to 20 N before the first strengthened glass substrate fractures.

Aspect (18) of this disclosure pertains to the laminate of any one or more of Aspect (15) through Aspect (17), wherein the first strengthened glass substrate can withstand an Indentation Fracture Measurement using a Vickers indenter and a load of at least 12 N before the first strengthened glass substrate fractures.

Aspect (19) of this disclosure pertains to the laminate of any one or more of Aspect (15) through Aspect (18), wherein the first strengthened glass substrate has a first thickness in the range of about 0.3 mm to about 2 mm.

Aspect (20) of this disclosure pertains to a vehicle comprising: a vehicle body defining an interior and comprising at least one opening forming a window to an exterior; and the laminate according to any one or more of Aspect (1) through Aspect (19) disposed in the opening, wherein the vehicle comprises an automobile, seacraft, aircraft, or a train.

Aspect (21) pertains to the vehicle of Aspect (20), wherein the first strengthened glass substrate faces the exterior and the second strengthened glass substrate faces the interior.

Aspect (22) pertains to the vehicle of Aspect (20), wherein the first strengthened glass substrate faces the interior and the second strengthened glass substrate faces the exterior.

Aspect (23) pertains to a method of manufacturing a laminate comprising: arranging a first strengthened glass substrate, an interlayer, and a second strengthened glass substrate in a stack, the first strengthened glass substrate having a first central tension value defined by a first thickness, a first compressive stress depth of layer, and a first compressive stress magnitude, the second strengthened glass substrate having a second substrate central tension value defined by a second thickness, a second compressive stress depth of layer, and a second compressive stress magnitude, wherein the first central tension value is less than the second central tension value; and applying heat and pressure to the stack to form the laminate.

Although the disclosure herein has been described with reference to particular embodiments, it is to be understood that these embodiments are merely illustrative of the principles and applications of the present disclosure. It will be apparent to those skilled in the art that various modifications and variations can be made to the method and apparatus of the present disclosure without departing from the spirit and scope of the disclosure. Thus, it is intended that the present disclosure include modifications and variations that are within the scope of the appended claims and their equivalents.

1. A laminate comprising:
a first strengthened glass substrate having a first central tension value defined by a first thickness, a first compressive stress depth of layer, and a first compressive stress magnitude; and
a second strengthened glass substrate having a second central tension value defined by a second thickness, a second compressive stress depth of layer, and a second compressive stress magnitude, wherein the first central tension value is less than the second central tension value.

2. The laminate of claim 1, wherein the first central tension value is 20 MPa or less.

3. The laminate of claim 1, wherein the second compressive stress depth of layer is greater than 40 μm.

4. The laminate of claim 1, wherein the first compressive stress depth of layer is at least 45 μm, and the first central tension value is 30 MPa or less.

5. The laminate of claim 1, wherein the first thickness is in the range of about 0.3 mm to about 2 mm, the first compressive stress magnitude is in the range of about 300 MPa to about 1000 MPa, and the first central tension value is 30 MPa or less.

6. The laminate of claim 1, wherein the first strengthened glass substrate has a different glass composition than the second strengthened glass substrate.

7. The laminate of claim 1, wherein the first strengthened glass substrate is laminated to the second strengthened glass substrate by an interlayer.

8. The laminate of claim 7, wherein the interlayer is a polymer interlayer selected from the group consisting of polyvinyl butyral, ethylenevinylacetate, polyvinyl chloride, ionomers, and thermoplastic polyurethane.

9. The laminate of claim 1, wherein the first thickness is greater than the second thickness, and the first thickness is in the range of 0.3 to 2 mm.

10. The laminate of claim 9, wherein a ratio of the first thickness to the second thickness is in the range of 2:1 to 10:1.

11. The laminate of claim 10, wherein the thickness of the laminate is less than 2.5 mm.

12. The laminate of claim 1, wherein the first compressive stress depth of layer is in the range of about 20 μm to about 170 μm for at least one surface.

13. The laminate of claim 12, wherein at least one surface of the first strengthened glass substrate has a compressive stress magnitude of at least 300 MPa.

14. The laminate of claim 1, wherein the laminate comprises any one of a heads-up display, a projection surface, an antenna, a surface modification and a coating.

15. A laminate comprising:
a first strengthened glass substrate having a first damage tolerance as measured by an Indentation Fracture Measurement; and
a second strengthened glass substrate having a second damage tolerance as measured by the same Indentation Fracture Measurement as the first damage tolerance, wherein the first strengthened glass substrate and the second strengthened glass substrate are laminated together, and the first damage tolerance is greater than the second damage tolerance,
wherein the first strengthened glass substrate has a first thickness in the range of about 0.3 mm to about 2 mm.

16. The laminate of claim 15, wherein at least one surface of the first strengthened glass substrate can withstand a surface flaw having a depth of at least 100 μm before the laminate suffers a fatigue-style failure.

17. The laminate of claim 15, wherein the first strengthened glass substrate can withstand an Indentation Fracture Measurement using a Vickers indenter and a load in the range of 8 N to 20 N before the first strengthened glass substrate fractures.

18. The laminate of claim 15, wherein the first strengthened glass substrate can withstand an Indentation Fracture Measurement using a Vickers indenter and a load of at least 12 N before the first strengthened glass substrate fractures.

19. (canceled)

20. A vehicle comprising:
a vehicle body defining an interior and comprising at least one opening forming a window to an exterior, and
the laminate according to claim 1 disposed in the opening, wherein the vehicle comprises an automobile, seacraft, aircraft, or a train.

21. (canceled)

22. (canceled)

23. A method of manufacturing a laminate comprising:
arranging a first strengthened glass substrate, an interlayer, and a second strengthened glass substrate in a stack, the first strengthened glass substrate having a first central tension value defined by a first thickness, a first compressive stress depth of layer, and a first compressive stress magnitude, the second strengthened glass substrate having a second substrate central tension value defined by a second thickness, a second compressive stress depth of layer, and a second compressive stress magnitude, wherein the first central tension value is less than the second central tension value; and
applying heat and pressure to the stack to form the laminate.
